(19) United States
(12) Patent Application Publication
(10) Pub. No.: US 2024/0199466 A1
(43) Pub. Date: Jun. 20, 2024

(54) WATER TREATMENT SYSTEM

(71) Applicant: DENSO CORPORATION, Kariya-city (JP)

(72) Inventors: Eriko MAEDA, Kariya-city (JP); Kei SUGIURA, Kariya-city (JP)

(21) Appl. No.: 18/592,819

(22) Filed: Mar. 1, 2024

Related U.S. Application Data
(63) Continuation of application No. PCT/JP2022/028538, filed on Jul. 22, 2022.

(30) Foreign Application Priority Data
Sep. 7, 2021 (JP) 2021-145472

(51) Int. Cl. C02F 9/00; B01D 3/14; B01D 61/02; B01D 61/36; B01D 61/58; B01D 71/02; C02F 1/04; C02F 1/44; C02F 103/34

(52) U.S. Cl. CPC C02F 9/00; B01D 3/145; B01D 61/58; B01D 71/02; B01D 61/025; B01D 61/364; B01D 2311/08; B01D 2317/022; C02F 1/04; C02F 1/441; C02F 1/447; C02F 2103/34; C02F 2303/10

(57) ABSTRACT

A water treatment system includes a reverse-osmosis membrane separation device and a ceramic membrane separation device. The reverse-osmosis membrane separation device separates treatment water into first concentrated water and first purified water by a reverse osmosis membrane. The ceramic membrane separation device includes a ceramic membrane having a porosity permeable to water vapor and impermeable to liquid water, and the ceramic membrane separation device separates the first concentrated water into second concentrated water and second purified water.

### CROSS REFERENCE TO RELATED APPLICATIONS

The present application is a continuation application of International Patent Application No. PCT/JP2022/028538 filed on Jul. 22, 2022, which designated the U.S. and claims the benefit of priority from Japanese Patent Application No. 2021-145472 filed on Sep. 7, 2021. The entire disclosures of all of the above applications are incorporated herein by reference.

### TECHNICAL FIELD

The present disclosure relates to a water treatment system.

### BACKGROUND

A water treatment device purifies water such as factory wastewater.

### SUMMARY

According to at least one embodiment, a water treatment system includes a reverse-osmosis membrane separation device and a ceramic membrane separation device. The reverse-osmosis membrane separation device separates treatment water into first concentrated water and first purified water by a reverse osmosis membrane. The ceramic membrane separation device includes a ceramic membrane having a porosity permeable to water vapor and impermeable to liquid water, and the ceramic membrane separation device separates the first concentrated water into second concentrated water and second purified water.

### BRIEF DESCRIPTION OF DRAWINGS

The details of one or more embodiments are set forth in the accompanying drawings and the description below. Other features and advantages will be apparent from the description and drawings, and from the claims.

FIG. 1 is an explanatory diagram illustrating a water treatment system according to a first embodiment.

FIG. 2 is an explanatory diagram illustrating a ceramic membrane separation device of the water treatment system according to the first embodiment.

FIG. 3 is an explanatory diagram illustrating a ceramic membrane separation device of a water treatment system according to a second embodiment.

FIG. 4 is an explanatory diagram illustrating the ceramic membrane separation device according to the second embodiment.

FIG. 5 is a cross-sectional view taken along a line V-V of FIG. 4.

FIG. 6 is an explanatory diagram illustrating a ceramic membrane separation device of a water treatment system according to the third embodiment.

FIG. 7 is an explanatory diagram illustrating a ceramic membrane separation device of a water treatment system according to a fourth embodiment.

FIG. 8 is an explanatory diagram illustrating a water treatment system according to a fifth embodiment.

FIG. 9 is an explanatory diagram illustrating a water treatment system according to a sixth embodiment.

FIG. 10 is an explanatory diagram illustrating a water treatment system according to a seventh embodiment.

FIG. 11 is an explanatory diagram illustrating a ceramic membrane separation device according to an eighth embodiment.

### DETAILED DESCRIPTION

To begin with, examples of relevant techniques will be described.

A water treatment device according to a comparative example purifies water such as factory wastewater. This water treatment device purifies water by separating the water into concentrated water and permeated water by a reverse osmosis membrane. That is, the purified water from which impurities such as dissolved salts contained in the water to be treated have been removed permeates the reverse osmosis membrane as permeate water.

The purification treatment by the reverse osmosis membrane is difficult when concentration of impurities such as dissolved salts in treatment water is high. That is, in the purification treatment using the reverse osmosis membrane, it is necessary to apply a pressure higher than an osmotic pressure to the treatment water. The osmotic pressure increases when the concentration of the impurities in the treatment water is high. Therefore, it is necessary to further increase the pressure applied to the reverse osmosis membrane. However, pressure resistance of the reverse osmosis membrane is limited. Therefore, the purification treatment by the reverse osmosis membrane is difficult when the impurity concentration in the treatment water is high. As a result, there is an issue that it is difficult to improve recovery rate of the purified water.

In contrast to the comparative example, according to a water treatment device of the present disclosure, a recovery rate of purified water can be improved.

According to one aspect of the present disclosure, a water treatment system includes a reverse-osmosis membrane separation device and a ceramic membrane separation device. The reverse-osmosis membrane separation device separates treatment water into first concentrated water and first purified water by a reverse osmosis membrane. The ceramic membrane separation device includes a ceramic membrane having a porosity permeable to water vapor and impermeable to liquid water, and the ceramic membrane separation device separates the first concentrated water into second concentrated water and second purified water.

According to this configuration, the water treatment system includes the ceramic membrane separation device. As a result, the first concentrated water can be separated into the second concentrated water and the second purified water. The ceramic membrane separation device is capable of separating the first concentrated water into the second concentrated water and the second purified water even if the impurity concentration of the first concentrated water d1 is high. Therefore, the second concentrated water having a higher impurity concentration can be obtained. As a result, the second purified water can be obtained in addition to the first purified water, and the purified water can be obtained at a higher ratio. That is, the recovery rate of the purified water can be improved.

As described above, the above aspect enables the provision of a water treatment system capable of improving the recovery rate of purified water.

### First Embodiment

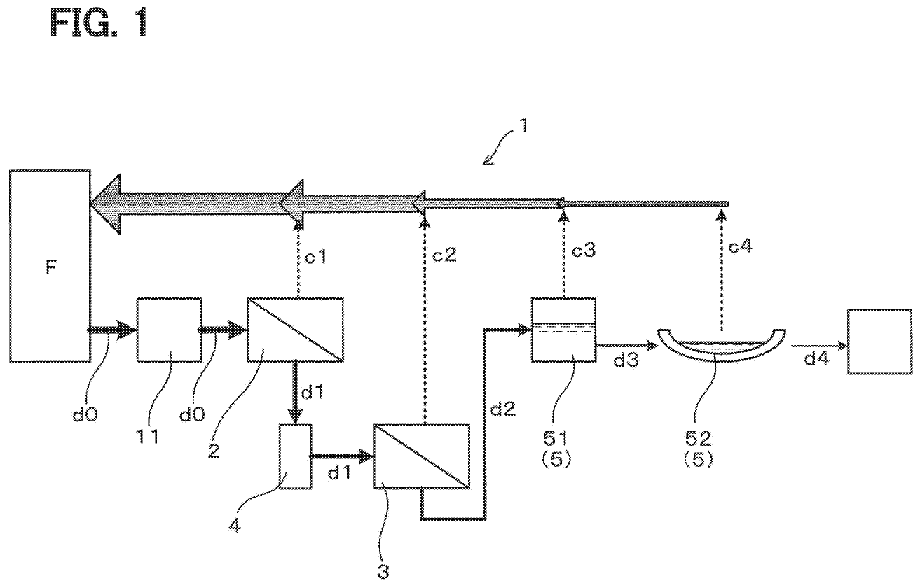

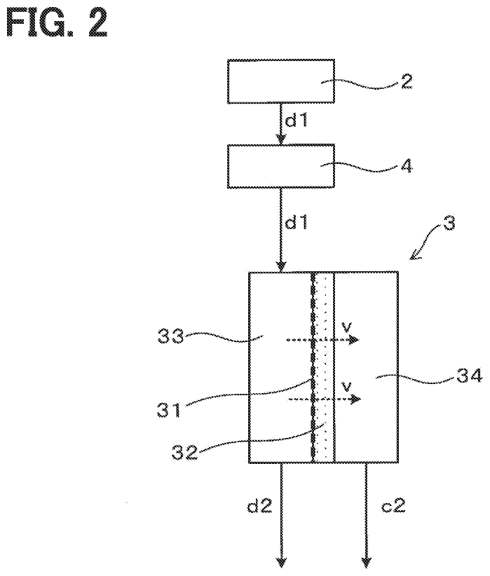

A first embodiment of a water treatment system 1 will be described with reference to FIGS. 1, 2. As shown in FIG. 1, the water treatment system 1 of the present embodiment includes a reverse-osmosis membrane separation device 2 and a ceramic membrane separation device 3. The reverse-osmosis membrane separation device 2 separates first water d0 into a first concentrated water d1 and a first purified water c1 by a reverse osmosis membrane. The first water is water to be treated. The ceramic membrane separation device 3 includes a porous ceramic membrane 31 that transmits water vapor without transmitting liquid water (see FIG. 2). Then, the ceramic membrane separation device 3 separates the first concentrated water d1 into a second concentrated water d2 and a second purified water c2.

As shown in FIG. 1, the water treatment system 1 of the present embodiment further includes a heating device 4 that heats the first concentrated water d1. The heating device 4 heats the first concentrated water d1 to 40° C. or higher. More preferably, the heating device 4 heats the first concentrated water d1 to 60° C. or higher.

The water treatment system 1 of the present embodiment further includes a distillation device 5 that distills the second concentrated water d2. The distillation device 5 includes an evaporator 51 and a crystallizer 52. The evaporator 51 distills the second concentrated water d2 by heating or reducing pressure, or by combining heating and reducing the pressure. The crystallizer 52 is at a subsequent stage of the evaporator 51. A third concentrated water d3 remaining after the distilled water c3 is evaporated by the evaporator 51 is sent to the crystallizer 52. The crystallizer 52 distills the third concentrated water d3 by heating it. After the distilled water c4 is evaporated by the crystallizer 52, crystals of impurity d4 remain. Various substances may remain as impurities, and depending on a type thereof, the impurities are used as valuable materials or discarded as industrial waste.

The first purified water c1 taken out in the reverse-osmosis membrane separation device 2, the second purified water c2 taken out in the ceramic membrane separation device 3, the distilled water c3 taken out in the evaporator 51, and the distilled water c4 taken out in the crystallizer 52 may be recovered and reused.

The water treatment system 1 of the present embodiment is a system for purifying factory wastewater discharged from a factory F. That is, the first water d0 is factory wastewater. However, the first water d0 is pretreated in the pretreatment device 11 before being introduced into the reverse-osmosis membrane separation device 2. That is, the pretreatment device 11 is a device that removes various substances contained in factory wastewater. Examples of the substances contained in factory wastewater include oil, high COD substances, heavy metals, fluorides, phosphoric acid compounds, Cl, SO₄, Na, Mg, and CaCO₃ (calcium carbonate). The high COD substance refers to a substance having a high chemical oxygen demand (COD).

The first water d0 from which a certain amount or more of the contained substances have been removed from the factory wastewater by the pretreatment device 11 is supplied to the reverse-osmosis membrane separation device 2. The first water d0 mainly contains salt. This salt is removed in the steps subsequent to the reverse-osmosis membrane separation device 2.

As described above, the first concentrated water d1 separated from the first purified water c1 in the reverse-osmosis membrane separation device 2 is heated in the heating device 4. Thereafter, the first concentrated water d1 is supplied to the ceramic membrane separation device 3. As described above, the second purified water c2 and the second concentrated water d2 separated in the ceramic membrane separation device 3 are sequentially sent to the evaporator 51 and the crystallizer 52 in the distillation device 5. Then, the first purified water c1, the second purified water c2, and the distilled water c3, c4 obtained in each step are recovered and reused in the factory F.

The reverse-osmosis membrane separation device 2 includes, for example, an organic membrane such as cellulose acetate or aromatic polyamide as a reverse osmosis membrane. In the reverse-osmosis membrane separation device 2, the first water d0 is permeated through the reverse osmosis membrane by pressurizing the first water d0 and the first concentrated water d1 so as to be higher than the osmotic pressure. As a result, the first purified water c1 is obtained. However, as concentration of the first concentrated water d1 increases, the osmotic pressure increases. Therefore, there is a limit to the concentration of the first concentrated water d1 in consideration of the pressure resistance strength and the like of the reverse osmosis membrane. Therefore, salt concentration in the first concentrated water d1 can be increased only to a certain degree (for example, about 8%).

Therefore, in the water treatment system 1 of the present embodiment, the ceramic membrane separation device 3 is provided downstream of the reverse-osmosis membrane separation device 2. FIG. 2 is a schematic diagram of the ceramic membrane separation device 3. The ceramic membrane separation device 3 includes a ceramic membrane 31 formed on a surface of porous substrate 32.

As described above, the ceramic membrane 31 is permeable to water vapor but not to liquid water. The ceramic membrane 31 has hydrophobicity. The ceramic membrane 31 can be made of, for example, zeolite, silica, alumina, zirconia, SiC, or a composite material thereof. The ceramic membrane 31 may have a pore size of 1 μm or less. More preferably, the pore size of the ceramic membrane 31 may be 0.1 μm or less.

The porous substrate 32 can be made of ceramic such as alumina or cordierite. The porous substrate 32 has a thickness sufficient to maintain its shape. In addition, the pores are formed to such an extent that the permeation of water vapor in the ceramic membrane 31 is not inhibited. That is, the porous substrate 32 has a larger pore diameter and a larger porosity than the ceramic membrane 31.

In the ceramic membrane separation device 3, a supply flow path 33 and a recovery flow path 34 are provided on a first surface and a second surface which are opposite surfaces of the ceramic membrane 31, respectively. The porous substrate 32 is interposed between the supply flow path 33 and the recovery flow path 34 together with the ceramic membrane 31. The first concentrated water d1 is supplied to the supply flow path 33. The water vapor v generated from the first concentrated water d1 supplied to the supply flow path 33 passes through the ceramic membrane 31 and reaches the recovery flow path 34. The second purified water c2 is obtained by condensing the water vapor v that has passed through the recovery flow path 34. As a result, the first concentrated water d1 in the supply flow path 33 is re-concentrated to become the second concentrated water d2.

In this way, in the ceramic membrane separation device 3, the first concentrated water d1 is separated into the second concentrated water d2 and the second purified water c2. As a method of this separation, a plurality of types of methods can be considered. More specifically, a membrane distillation method and a pervaporation method are assumed. A plurality of types of methods can also be applied to the membrane distillation method. This will be specifically described in the following embodiments.

The present embodiment provides the following actions and effects. The water treatment system 1 includes the ceramic membrane separation device 3. As a result, the first concentrated water d1 can be separated into the second concentrated water d2 and the second purified water c2. The ceramic membrane separation device 3 is capable of separating the first concentrated water d1 into the second concentrated water d2 and the second purified water c2 even if the impurity concentration of the first concentrated water d1 is high. Therefore, the second concentrated water d2 having a higher impurity concentration can be obtained. As a result, the second purified water c2 can be obtained in addition to the first purified water c1, and the purified water can be obtained at a higher ratio. That is, the recovery rate of the purified water can be improved.

That is, the reverse-osmosis membrane separation device 2 has a limit in the impurity concentration of the first water d0 that can be treated. Therefore, by performing the treatment by the ceramic membrane separation device 3 after the treatment by the reverse-osmosis membrane separation device 2, the first concentrated water d1 having a higher concentration can be separated. As a result, the second concentrated water d2 can be obtained, and the recovery rate of the purified water can be improved.

The ceramic membrane separation device 3 includes the ceramic membrane 31 as a separation membrane. Ceramics have high chemical resistance. Therefore, when a scale component in the first concentrated water d1 to be treated is deposited on the ceramic membrane 31, the scale component is easily removed by chemicals or the like. The scale component is a poorly soluble inorganic substance, for example, calcium carbonate, calcium sulfate, barium sulfate, strontium sulfate, calcium fluoride, and silica.

The water treatment system 1 further includes the heating device 4. Ceramic has high heat resistance and can ensure durability even when the treatment water or the first water is at a high temperature. As a result, temperature of the first concentrated water d1 supplied to the ceramic membrane separation device 3 can be increased. As a result, precipitation of the scale component can be reduced when the impurity concentration of the first concentrated water d1 is high.

Further, the heating device 4 heats the first concentrated water d1 to 40° C. or higher. As a result, the precipitation of the scale component can be more effectively reduced.

In addition, the heating device 4 heats the first concentrated water d1 to 60° C. or higher, and thus effects of further easily preventing biofouling can be expected. That is, by raising the temperature of the first concentrated water d1 to 60° C. or higher, growth of microorganisms in the first concentrated water d1 can be prevented or the microorganisms can be killed. Accordingly, the biofouling and a frequency of cleaning of the ceramic membrane separation device 3 can be reduced.

The water treatment system 1 further includes the distillation device 5 for distilling the second concentrated water d2. As a result, the recovery rate of purified water can be further improved. In addition, even when the distillation device 5 is provided in the subsequent stage, the ceramic membrane separation device 3 is provided between the reverse-osmosis membrane separation device 2 and the distillation device 5, so that an amount of treatment water in the distillation device 5 can be reduced. As a result, distillation treatment energy in the distillation device 5 can be reduced. Additionally, the distillation device 5 can be easily downsized.

In particular, as a required level of ZLD (abbreviation of Zero Liquid Discharge) increases, the treatment in the distillation device 5 may be necessary. In this case, when the amount of wastewater to be treated in the distillation device 5 (that is, the second concentrated water d2) increases, the treatment energy in the distillation device 5 increases. Therefore, reducing the amount of the second concentrated water d2 sent to the distillation device 5 as much as possible is desirable. From such a viewpoint, by providing the ceramic membrane separation device 3 in the front stage of the distillation device 5, the amount of the second concentrated water d2 can be reduced and the processing energy in the distillation device 5 can be reduced. As a result, the energy efficiency of the water treatment system 1 as a whole can be improved.

As described above, the present embodiment enables the provision of a water treatment system capable of improving the recovery rate of purified water.

### Second Embodiment

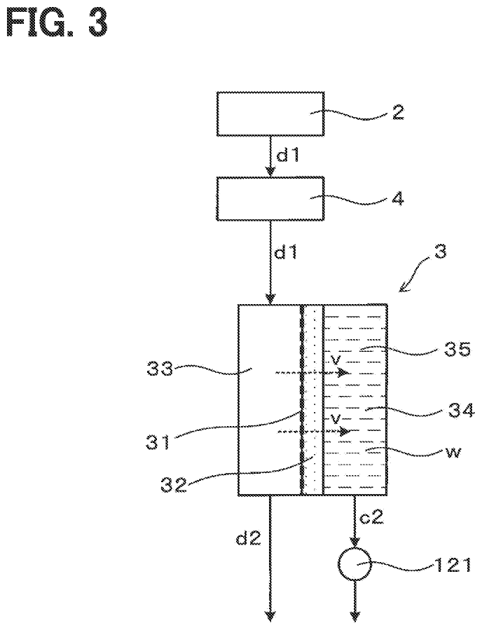

As shown in FIGS. 3 to 5, the present embodiment is a water treatment system 1 in which the ceramic membrane separation device 3 utilizes a difference in vapor pressure between a first surface and a second surface which are opposite surface of the ceramic membrane 31. That is, the ceramic membrane separation device 3 separates the first concentrated water d1 into the second concentrated water d2 and the second purified water c2 using the vapor pressure difference described above.

In particular, in the present embodiment, a case where the ceramic membrane separation device 3 uses a direct contact membrane distillation method will be described. That is, the ceramic membrane separation device 3 includes the supply flow path 33 through which the first concentrated water d1 flows and a low-temperature flow path 35 through which a low temperature water w having a lower temperature than the first concentrated water d1 flows. The supply flow path 33 and the low-temperature flow path 35 are arranged adjacent to each other with the ceramic membrane 31 interposed therebetween.

In the ceramic membrane separation device 3, a temperature difference occurs between the first concentrated water d1 supplied to the supply flow path 33 and the low temperature water w flowing through the low-temperature flow path 35. Accordingly, a vapor pressure difference is generated between the supply flow path 33 and the low-temperature flow path 35. As a result, the water vapor v of the first concentrated water d1 passes through the ceramic membrane 31 from the supply flow path 33 and is condensed in the low-temperature flow path 35. Therefore, a part of moisture of the first concentrated water d1 is recovered in the low-temperature flow path 35. That is, the low-temperature flow path 35 is also a recovery flow path 34 for recovering the second purified water c2.

In the present embodiment, a pump 121 is provided in the low-temperature flow path 35 which is also the recovery flow path 34. The pump 121 collects the second purified water c2 together with the low temperature water w. The low temperature water w is water after purification.

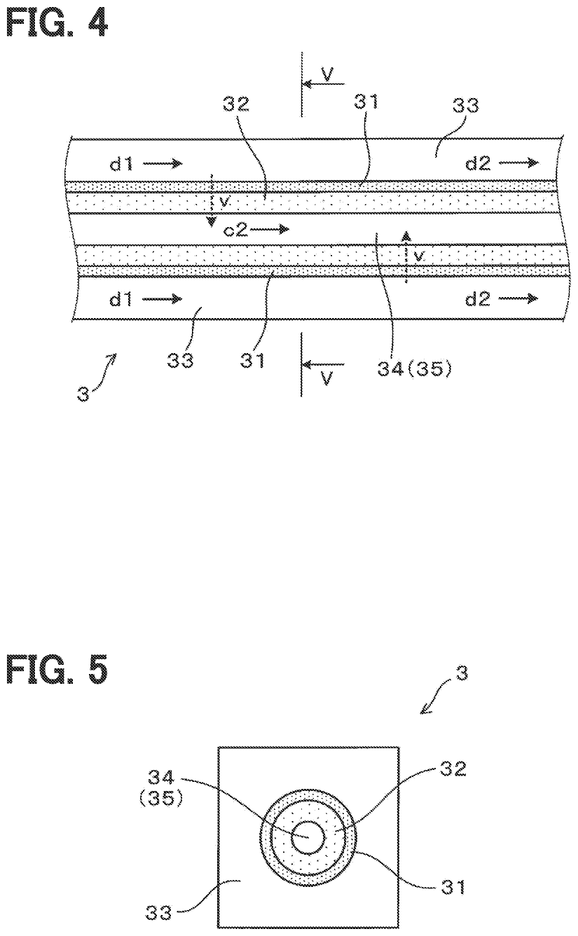

An example of a specific shape of the ceramic membrane separation device 3 is shown in FIGS. 4 and 5. The ceramic membrane separation device 3 has a porous substrate 32 having a tubular shape. The supply flow path 33 is arranged outside the tubular porous substrate 32, and the low-temperature flow path 35, which is the recovery flow path 34, is arranged inside the porous substrate 32. A ceramic membrane 31 is arranged on an outer peripheral surface of the porous substrate 32.

The rest is the same as that of the first embodiment. Those of reference numerals used in the second and subsequent embodiments which are the same reference numerals as those used in the above-described embodiments denote the same components as in the previous embodiments unless otherwise indicated.

In the present embodiment, the first concentrated water d1 can be separated into the second purified water c2 and the second concentrated water d2 by using the difference in vapor pressure between the supply flow path 33 and the recovery flow path 34. As a result, even when the impurity concentration of the first concentrated water d1 is high, the purification treatment can be easily performed. In addition, by using the direct contact membrane distillation method, the temperature difference between the supply flow path 33 and the recovery flow path 34 is easily increased, and the vapor pressure difference is easily increased. As a result, permeation flux of the water vapor v in the ceramic membrane 31 can be made relatively large. In addition, the structure of the ceramic membrane separation device 3 can be relatively simplified. In addition, the second embodiment has the same actions and effects as in the first embodiment.

### Third Embodiment

The present embodiment is also an embodiment of the water treatment system 1 in which the ceramic membrane separation device 3 utilizes a vapor pressure difference between the first surface and the second surface of the ceramic membrane 31.

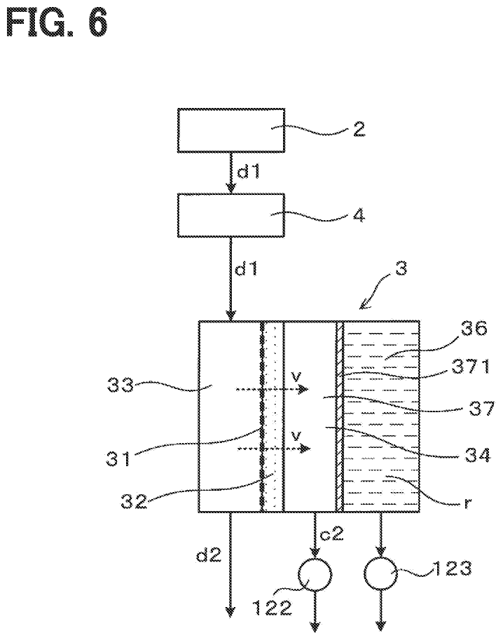

However, in the present embodiment, as shown in FIG. 6, a ceramic membrane separation device 3 includes a supply flow path 33, a coolant flow path 36, and an air gap 37. The supply flow path 33 is a channel through which the first concentrated water d1 flows. The coolant flow path 36 is a channel through which a coolant having a temperature lower than that of the first concentrated water d1 flows. The air gap 37 is arranged between the supply flow path 33 and the coolant flow path 36. The supply flow path 33 and the air gap 37 are arranged adjacent to each other with the ceramic membrane 31 interposed therebetween.

That is, in the present embodiment, the ceramic membrane separation device 3 is a device using an air gap membrane distillation method. In the ceramic membrane separation device 3, the coolant r having a lower temperature than the first concentrated water d1 supplied to the supply flow path 33 flows through the coolant flow path 36. Accordingly, the temperature of the air gap 37 adjacent to the coolant flow path 36 across a partition wall 371 becomes lower than that of the supply flow path 33. Due to the temperature difference generated between the air gap 37 and the supply flow path 33, a vapor pressure difference is generated between the supply flow path 33 and the air gap 37. As a result, the water vapor v of the first concentrated water d1 passes through the ceramic membrane 31 from the supply flow path 33 and is condensed in the air gap 37. More specifically, on a surface of the partition wall 371 in the air gap 37, the water vapor v is condensed and adheres as liquid water. In this way, a part of moisture of the first concentrated water d1 is recovered to the air gap 37. That is, the air gap 37 also serves as the recovery flow path 34 for recovering the second purified water c2.

In the present embodiment, a pump 122 is provided in the air gap 37 which is also the recovery flow path 34. The second purified water c2 is recovered by the pump 122. The coolant r flowing through the coolant flow path 36 is not particularly limited as long as the coolant r is a fluid, for example, water, oil, or seawater. Further, unlike the low temperature water w flowing through the low-temperature flow path 35 in the second embodiment, the water is not particularly required to be purified water. The coolant r in the coolant flow path 36 is circulated by a pump 123. The rest is the same as that of the first embodiment.

Also in the present embodiment, the first concentrated water d1 can be separated into the second purified water c2 and the second concentrated water d2 by using the difference in vapor pressure between the supply flow path 33 and the recovery flow path 34. As a result, even when the impurity concentration of the first concentrated water d1 is high, the purification treatment can be easily performed. Additionally, the air gap contact membrane distillation method eliminates need to specifically use water after distillation as the coolant r flowing through the coolant flow path 36. Therefore, degree of freedom of the system can be improved. In addition, the second embodiment has the same actions and effects as in the first embodiment.

### Fourth Embodiment

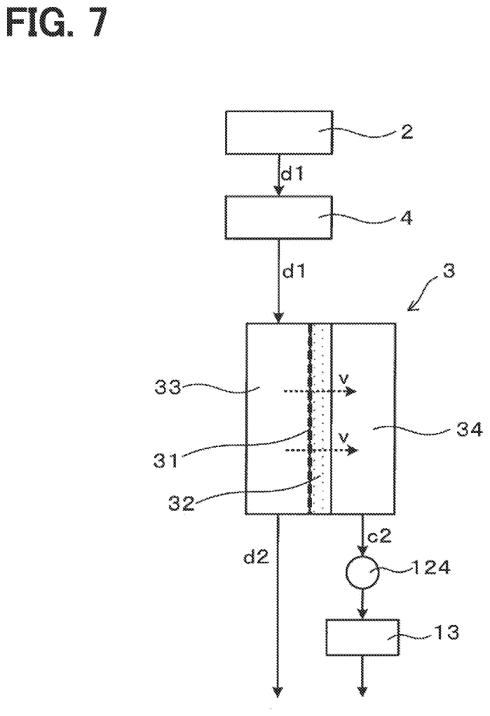

In the present embodiment, as shown in FIG. 7, a water treatment system 1 is configured such that a recovery flow path 34 in a ceramic membrane separation device 3 is brought close to vacuum. That is, a vacuum pump 124 is connected to the recovery flow path 34, and a pressure in the recovery flow path 34 can be sufficiently lowered. A cooler 13 is connected to the recovery flow path 34 via the vacuum pump 124.

In the ceramic membrane separation device 3, the water vapor v permeates through the ceramic membrane 31 mainly due to a pressure difference between the supply flow path 33 and the recovery flow path 34. Then, the water vapor v that has reached the recovery flow path 34 is condensed in the cooler 13 to be recovered as liquid water.

In the present embodiment, the first concentrated water d1 supplied to the supply flow path 33 is heated by the heating device 4. Therefore, the temperature of the supply flow path 33 is higher than that of the recovery flow path 34. That is, a slight temperature difference occurs between the supply flow path 33 and the recovery flow path 34, and a vapor pressure difference also occurs. Therefore, due to this vapor pressure difference, a part of the water vapor v that has passed through the ceramic membrane 31 is condensed into liquid water also in the recovery flow path 34.

As described above, as a method of obtaining purified water by bringing the recovery flow path 34 close to vacuum, there are a so-called vapor membrane distillation method and a so-called pervaporation separation method. When the vapor membrane distillation method is used, it is assumed that the ceramic membrane 31 has hydrophobicity as in the second embodiment and the third embodiment. A pore size of the ceramic membrane 31 is set to a nano level, for example, about 1 to 100 nm when the pervaporation separation method is used. The rest is the same as that of the first embodiment.

In the present embodiment, a permeation flux of the water vapor v permeating the ceramic membrane 31 can be improved. In addition, the second embodiment has the same actions and effects as in the first embodiment.

### Fifth Embodiment

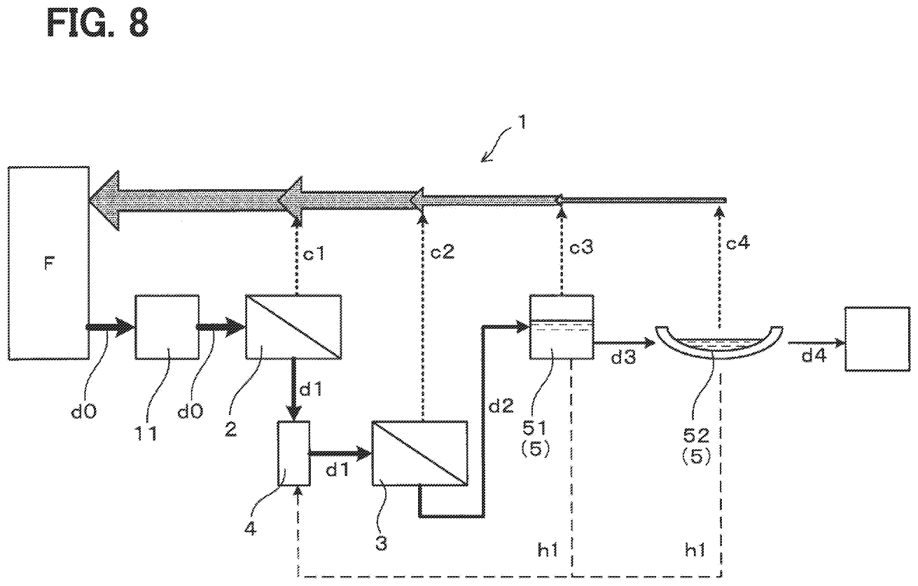

As shown in FIG. 8, the present embodiment is a water treatment system 1 in which a heating device 4 heats the first concentrated water d1 by exhaust heat h1 or waste heat h1 of the distillation device 5.

For example, in a crystallizer 52 which is one of distillation devices 5, the third concentrated water d3 is heated. During this heating, part of the heat is usually generated as waste heat h1. The waste heat h1 is used in the heating device 4. For example, the waste heat h1 in the crystallizer 52 may be sent to the heating device 4 using a fluid such as water, oil, or gas as a heat medium.

The waste heat h1 may be used in the heating device 4 when the waste heat h1 is generated in an evaporator 51. In the heating device 4, the waste heat h1 of the distillation device 5 can be used together with an external heat source. Alternatively, the heating device 4 may heat the first concentrated water d1 using only the waste heat h1 of the distillation device 5 when the waste heat h1 of the distillation device 5 is large. The rest is the same as that of the first embodiment.

In the present embodiment, the heating device 4 is capable of heating the first concentrated water d1 using the waste heat h1 of the distillation device 5. As a result, the energy efficiency of the water treatment system 1 as a whole can be improved. In addition, the second embodiment has the same actions and effects as in the first embodiment.

### Sixth Embodiment

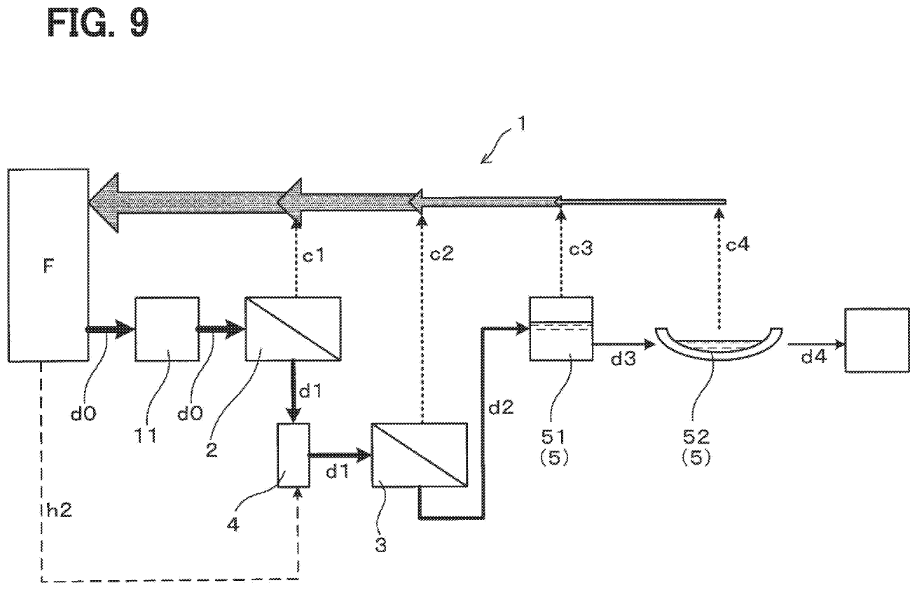

As shown in FIG. 9, the present embodiment is a water treatment system 1 in which the heating device 4 is heats the first concentrated water d1 by factory waste heat h2 or factory exhaust heat h2 discharged from the factory F.

The first water d0 to be purified in the water treatment system 1 is factory wastewater discharged from the factory F. In this plant, heat is also discharged. In the present embodiment, the factory waste heat h2 is used in the heating device 4.

For example, the factory waste heat h2 may be sent to the heating device 4 using a fluid such as water, oil, or gas as a heat medium.

In the heating device 4, the factory waste heat h2 may be used together with an external heat source. Alternatively, in the heating device 4, the factory waste heat h2 may be used together with the waste heat of the distillation device 5. The heating device 4 can also heat the first concentrated water d1 using only the factory waste heat h2. The rest is the same as that of the first embodiment.

In the present embodiment, the heating device 4 is capable of heating the first concentrated water d1 using the factory waste heat h2. As a result, the energy efficiency of the water treatment system 1 as a whole can be improved. In addition, the second embodiment has the same actions and effects as in the first embodiment.

### Seventh Embodiment

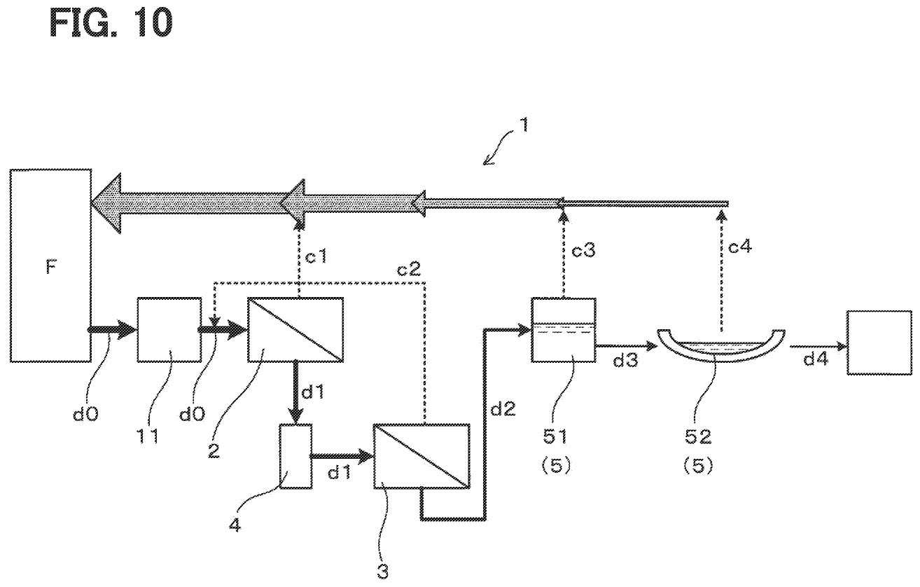

As shown in FIG. 10, the present embodiment is a water treatment system 1 configured to return a second purified water c2 obtained in a ceramic membrane separation device 3 to an upstream side of a reverse-osmosis membrane separation device 2. That is, the second purified water c2 separated from the second concentrated water d2 in the ceramic membrane separation device 3 is separated again in the reverse-osmosis membrane separation device 2. As a result, purified water having a high degree of purification obtained by further purifying the second purified water c2 is recovered. The rest is the same as that of the first embodiment.

In the present embodiment, the purified water having the high degree of the purification can be more reliably obtained. In addition, the second embodiment has the same actions and effects as in the first embodiment.

### Eighth Embodiment

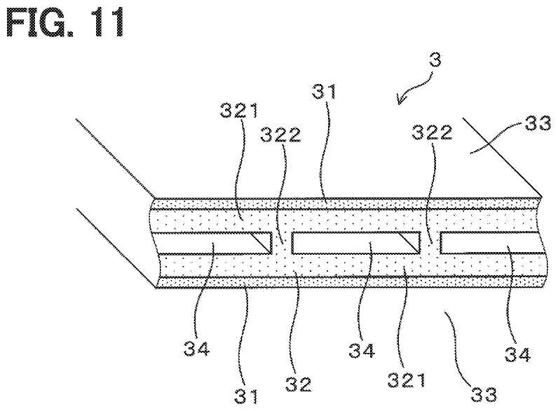

In the present embodiment, as shown in FIG. 11, a shape of a ceramic membrane 31 in a ceramic membrane separation device 3 is a flat plate shape.

That is, a porous substrate 32 has a pair of flat plate portions 321 arranged in parallel while providing a recovery flow path 34 therebetween. A supply flow path 33 is formed outside the pair of flat plate portions 321. The pair of flat plate portions 321 are fixed to each other by a plurality of connecting portions 322. The recovery flow path 34 is formed between the pair of flat plate portions 321 and the plurality of connecting portions 322. The ceramic membrane 31 is formed on at least a part of an outer surface of the pair of flat plate portions 321. A dense film (not shown) is formed on a portion of the outer surface of the pair of flat plate portions 321 where the ceramic membrane 31 is not formed. The rest is the same as that of the second embodiment. In this embodiment as well, the same actions and effects as in the second embodiment can be obtained.

The present disclosure is not limited to the respective embodiments described above, and various modifications may be adopted within the scope of the present disclosure without departing from the spirit of the disclosure.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A water treatment system comprising:
a reverse-osmosis membrane separation device configured to separate treatment water into first concentrated water and first purified water by a reverse osmosis membrane; and
a ceramic membrane separation device including a ceramic membrane having a porosity permeable to water vapor and impermeable to liquid water, the ceramic membrane separation device being configured to separate the first concentrated water into second concentrated water and second purified water.

2. The water treatment system according to claim 1, further comprising
a heating device configured to heat the first concentrated water.

3. The water treatment system according to claim 2, wherein
the heating device is configured to heat the first concentrated water to 40° C. or higher.

4. The water treatment system according to claim 2, wherein
the heating device is configured to heat the first concentrated water to 60° C. or higher.

5. The water treatment system according to claim 2, further comprising
a distillation device configured to distill the second concentrated water, wherein
the heating device is configured to heat the first concentrated water by waste heat of the distillation device.

6. The water treatment system according to claim 1, further comprising
a distillation device configured to distill the second concentrated water.

7. The water treatment system according to claim 2, wherein
the treatment water is factory wastewater discharged from a factory, and
the heating device is configured to heat the first concentrated water by factory waste heat discharged from the factory.

8. The water treatment system according to claim 1, wherein
the ceramic membrane separation device is configured to separate the first concentrated water into the second concentrated water and the second purified water by using a vapor pressure difference between a first surface and a second surface which are opposite surfaces of the ceramic membrane.

9. The water treatment system according to claim 8, wherein
the ceramic membrane separation device includes a supply flow path through which the first concentrated water passes, and a low-temperature flow path through which low-temperature water having a lower temperature than the first concentrated water passes, and
the supply flow path and the low-temperature flow path are arranged adjacent to each other with the ceramic membrane interposed between the supply flow path and the low-temperature flow path.

10. The water treatment system according to claim 8, wherein
the ceramic membrane separation device includes a supply flow path through which the first concentrated water passes, a coolant flow path through which coolant having a lower temperature than the first concentrated water passes, and an air gap arranged between the supply flow path and the coolant flow path, and
the supply flow path and the air gap are arranged adjacent to each other with the ceramic membrane interposed between the supply flow path and the coolant flow path.
